(19) United States
(12) Patent Application Publication
(10) Pub. No.: US 2022/0067852 A1
(43) Pub. Date: Mar. 3, 2022

(54) CHARGING COMMUNICATION SYSTEM

(71) Applicant: AUDI AG, Ingolstadt (DE)

(72) Inventor: Armin PÖPPEL, Gaimersheim (DE)

(21) Appl. No.: 17/410,762

(22) Filed: Aug. 24, 2021

(30) Foreign Application Priority Data
Aug. 25, 2020 (DE) 102020122104.5

(51) Int. Cl. G06Q 50/06; H04W 4/40

(52) U.S. Cl. CPC G06Q 50/06; H04W 84/12; H04W 4/40

(57) ABSTRACT

A charging communication system for at least one electric vehicle comprises a back end and at least one wall box, each wall box comprising a control unit with a communication unit, wherein the charging communication system comprises at least one application which is set up on at least one terminal, wherein the charging communication system is set up, via a first application, to transmit information to a first communication unit of a first wall box and to receive it from the first communication unit, wherein the first communication unit is set up to transmit the at least one piece of information received from an application to the back end.

### BACKGROUND

### Technical Field

Embodiments of the present invention relate to a charging communication system for at least one electric vehicle comprising a back end and at least one wall box, each comprising a control unit with a communication unit.

### Description of the Related Art

Charging systems in the form of wall box systems are known. A wall box requires a connection to a three-phase network and has a type 2 charging plug for connection to a motor vehicle. A privately purchased wall box is usually only used within one household.

From document U.S. Pat. No. 9 434 270 B1, charging units for charging an electric vehicle and methods for cloud access and for programming data for charging units are known.

From document WO 2011 094 627 A1, an electric vehicle charging station network is known with several electric vehicle charging stations belonging to several charging station hosts. Each host controls one or more charging stations. A charging station network server provides an interface, via which each of the hosts can define one or more price specifications for charging electric vehicles on one or more of their charging stations for electric vehicles belonging to this host. The price specifications are applied to the charging stations so that the cost of charging electric vehicles with these charging stations is calculated according to the price specifications.

From document DE 10 2018 214 986 A1, a device for route planning of an electric vehicle is known, wherein the device comprises an input interface for receiving a current state of charge of an energy store of the electric vehicle and a planned route of the electric vehicle, and a database interface for receiving charging station information with positions of charging stations.

The application software known in the prior art disclose a wall box charging option for third parties in direct personal consultation with an owner of the respective wall box.

### BRIEF SUMMARY

Some embodiments provide a charging communication system which is set up to enable use of a wall box by third parties without direct contact with the owner.

Some embodiments provide a charging communication system for at least one electric vehicle comprising a back end and at least one wall box, each comprising a control unit with a communication unit. The wall box is set up to provide a charging option for at least one electric vehicle.

In some embodiments, the charging communication system comprises at least one application, which is set up on at least one terminal device, wherein the charging communication system is set up to transmit information to a first communication unit of a first wall box of the at least one wall box and/or to receive it from the first communication unit via a first application of the at least one application, wherein the first communication unit is set up to transmit the at least one piece of information received from the first application to the back end.

The back end is set up as at least one server. A terminal is usually a mobile device. For example, a terminal is a mobile phone, a tablet or a smart watch. Usually, the at least one application is set up on a smart phone. This has the advantage that a use of the charging communication system is designed in a particularly simple manner for an owner of a wall box.

The charging communication system has the advantage that users can create their own community in order to achieve improved access to charging options. This increases the access options to charging options in entire regions, as private owners of wall boxes can actively make their own wall boxes available to the community. Due to the still very limited availability of charging options, this results in a great benefit for customers, especially for regions with little service, such as residential areas.

In particular, the charging communication system enables each individual wall box owner to independently display the availability of his wall box and to promote their own utilization of the wall box.

In a further development, the back end is set up to store the at least one piece of information transmitted by the first application via the first communication unit. The back end is thus set up to store information that is transmitted to the back end via communication units.

This has the advantage that information from at least two wall boxes is transmitted to a common back end respectively via a communication unit of a respective wall box. This has the advantage that the information from individual wall boxes is centralized in one storage unit. In addition, the charging communication system has the advantage that at least two wall boxes can access the back end separately from one another in order to obtain information regarding other wall boxes from the back end.

In a further development, the back end is set up to make the at least one stored piece of information of the first application available to an at least one further communication unit of at least one further wall box of the at least one wall box. Usually, the further communication unit is arranged in at least one further wall box.

The back end is set up to transmit the at least one piece of information to the second application on the second terminal. Usually, the charging communication system comprises at least two wall boxes. The charging communication system is set up in order to be expanded with further wall boxes.

The charging communication system is thus set up to allow access to information stored on the back end through at least two wall boxes. The application has the advantage that a simple option is provided to make an available wall box usable for several users. Optionally, the charging communication system is set up to restrict access to the back end to wall boxes that are located in a certain area.

For example, the charging communication system is set up to restrict access to the back end of at least one wall box to authorized persons or users. This has the advantage that the charging communication system can be restricted to use by known users or for a neighborhood.

In one arrangement, the charging communication system comprises at least two wall boxes, wherein each of the at least two wall boxes comprises a communication unit which is set up to connect a respective wall box to the back end.

In a further arrangement, the communication unit is a WLAN module, which is set up to connect the at least one wall box to the back end. The arrangement of the communication unit as a WLAN module has the advantage that a respective wall box is set up to provide information about the wall box to an Internet. The communication unit is set up to be controllable via the at least one application.

In a further development, the at least one application is set up as an owner application, which is set up, as an input device, to provide an input of a piece of information to the back end. The owner application is thus set up to enable an owner to make a wall box available to a community or at least to another user. For example, the owner application is set up to transmit an availability time of a wall box to the back end via the communication unit.

The availability time of the wall box stored in the back end can be called up via a further application. For example, an owner of a wall box can make his wall box available to other users within a certain time and a user can book a certain available time of availability. Thereby, no direct communication with the owner of the respective wall box is necessary, as both the provision and the booking take place indirectly via the charging communication system.

Optionally, the user application comprises a preset input mask, which is set up to query the owner of a wall box for information necessary for the provision. This accelerates the provision of the wall box for an owner, which also supports the acceptance of the application.

The user application is set up to actively request information from an owner and provide it to the back end. The user application is set up to record further information and to transmit it to the back end. For example, information is a fee or costs incurred for a charge at the respective wall box.

In a further development, at least one further application is designed as an access application, which is set up to communicate directly with the back end. The access application is thereby set up to obtain information from the back end and/or to transmit it to the back end, wherein the back end is set up to forward the information transmitted by the access application to a relevant owner application.

The access application is set up, for example, to call up availability information that was transmitted to the back end by a user application. A user can use the access application to book a period of time for a possible charge of an electric vehicle, which is reported by the availability information. The access application is thereby set up to call up further information made available on the back end.

For example, the access application is set up to call up cost information regarding a planned charge. Optionally, the access application is set up as a means of payment, wherein an availability period or the use of a wall box can be paid for directly via the access application.

The charging communication system comprises at least one owner application and at least one access application, wherein information about a respective wall box can be transmitted to the back end via the owner application and the transmitted information can be retrieved from the back end via an access application. In one arrangement, information transmitted by an owner application is an available time of a respective wall box.

In a further development, the charging communication system is set up to display the availability of at least one of the further wall boxes connected to one another via the back end. The charging communication system has the advantage that users or community members can view the availability of a wall box online. Alternatively, an application, in particular a respective access application, is set up to interactively display available wall boxes on a map.

In one arrangement, use of at least one available wall box can be booked via a respective application. For example, an available wall box can thereby be selected via a respective access application, wherein the wall box can be booked with binding effect.

In a further development, a statement of costs for charging by a respective owner of a respective wall box can be stored via a respective owner application. This has the advantage that the costs of available wall boxes can be viewed transparently for the users or community members. Billing of a charging process thereby usually takes place according to time.

The application is optionally set up as a means of payment, wherein a booked wall box can be paid for directly or after a charge. The application is optionally set up to provide a connection to a payment method. The billing function integrated in the application offers hotels, guest houses and shops a simple option to offer a charging point to a large number of people.

Some embodiments provide a wall box comprising an above-described charging communication system.

### BRIEF DESCRIPTION OF THE SEVERAL VIEWS OF THE DRAWINGS

FIG. 1 shows a charging communication system comprising at least two wall boxes.

### DETAILED DESCRIPTION

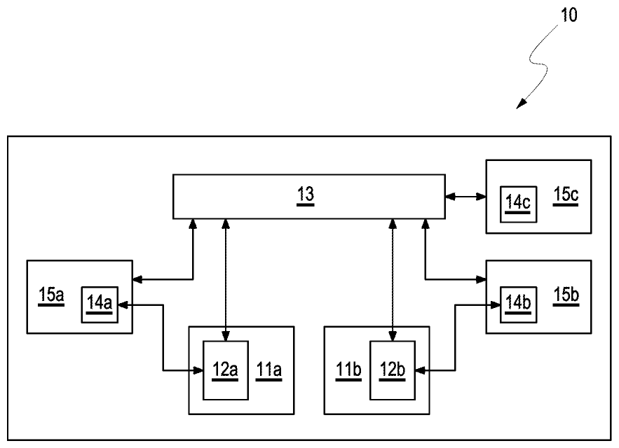

FIG. 1 shows the charging communication system 10 for at least one—not shown—electric vehicle. In the present embodiment, the charging communication system 10 comprises a back end 13 and two wall boxes 11a, 11b, which respectively comprise a control unit with a communication unit 12a, 12b.

In the present embodiment, the charging communication system 10 comprises three applications 14a, 14b, 14c, wherein two applications 14a, 14b are respectively set up as an owner application for controlling one of the wall boxes 11a, 11b and a third application 14c is set up as an access application, which is set up to access the information transmitted to the back end 13 by the owner applications 14a, 14b.

The owner applications 14a, 14b are thereby usually in the possession of an owner of a respective wall box 11a, 11b. The applications 14a, 14b, 14c are respectively set up on a terminal 15a, 15b, 15c. The charging communication system 10 is set up to transmit information about a respective wall box 11a, 11b to the back end 13 via a respective owner application 14a, 14b.

The charging communication system 10 is set up to access the information transmitted by the owner applications 14a, 14b via the at least one access application 14c. The owner applications 14a, 14b are also set up to access the information that is stored on the back end 13.

The back end 13 is set up to store the information received and to provide it to the applications 14a, 14b and 14c. A respective application 14a, 14b, 14c is thereby set up to access the information stored on the back end 13 via a respective communication unit 12a, 12b or directly via the respective terminal 15a, 15b, 15c on which the respective application 14a, 14b, 14c is set up.

A respective owner application 14a, 14b is thereby set up as an input device, via which an owner can carry out an input of information. The owner application 14a, 14b is set up to receive availability information from a wall box 11 and to transmit it to the back end 13.

For example, an owner of a wall box 11 can communicate via an owner application 14a, 14b that a wall box 11 is freely available at a certain time and can thus be used by other users.

The availability information of the wall box 11 is accordingly stored in the back end 13 and can be called up by a further user via a further application 14, in particular an access application 14c.

The back end 13 is set up to store the at least one piece of information transmitted by the first application 14a via the first communication unit 12a. The back end 13 is set up to make the at least one stored piece of information of the first application 14a available to an at least one further communication unit 12b of an at least one further wall box 11.

German patent application no. 10 2020 122 104.5, filed Aug. 25, 2020, to which this application claims priority, is hereby incorporated herein by reference in its entirety.

Aspects and features of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A charging communication system for at least one electric vehicle, comprising:
a back end;
a first wall box including a first control unit with a first communication unit; and
a first application set up on a first terminal,
wherein the first application is configured to transmit information to the first communication unit the first wall box and/or to receive information from the first communication unit of the first wall box, and
wherein the first communication unit is set up to transmit information received from the first application to the back end.

2. The charging communication system according to claim 1, wherein the back end is set up to store information received from the first application via the first communication unit.

3. The charging communication system according to claim 1, wherein the back end is set up to make the stored information available to an at least one further communication unit of at least one further wall box.

4. The charging communication system according to claim 1, further comprising at least two wall boxes, wherein each of the at least two wall boxes includes a communication unit, which is set up to connect a respective wall box to the back end.

5. The charging communication system according to claim 1, wherein the communication unit is a WLAN module which is set up to connect the at least one wall box to the back end.

6. The charging communication system according to claim 1, wherein the at least one application is set up as an owner application, which is set up as an input device to provide an input of a piece of information to the back end.

7. The charging communication system according to claim 6, wherein at least one further application is designed as an access application, which is set up to communicate directly with the back end.

8. The charging communication system according to claim 4, wherein the charging communication system is set up to display an availability of at least one of the wall boxes connected to one another via the back end.

9. The charging communication system according to claim 1, wherein use of at least one available wall box can be booked via a respective application.

10. The charging communication system according to claim 1, characterized in that a statement of costs for charging by a respective owner of a respective wall box can be stored via a respective owner application.
